(19) United States
(12) Patent Application Publication
(10) Pub. No.: US 2013/0168315 A1
(43) Pub. Date: Jul. 4, 2013

(54) REMOVAL OF FIELD CHEMICALS FROM PRODUCED WATER USING DIFFERENT MEMBRANE PROCESSES AND SYSTEM DEVELOPMENT

(71) Applicants: Joel E. MINIER MATAR, Doha (QA); Isik Riza TURKMEN, Doha (QA); Samir GHARFEH, Doha (QA); Samer ADHAM, Doha (QA); Altaf Ahmed HUSSAIN, Doha (QA)

(72) Inventors: Joel E. MINIER MATAR, Doha (QA); Isik Riza TURKMEN, Doha (QA); Samir GHARFEH, Doha (QA); Samer ADHAM, Doha (QA); Altaf Ahmed HUSSAIN, Doha (QA)

(73) Assignee: CONOCOPHILLIPS COMPANY, Houston, TX (US)

(21) Appl. No.: 13/644,212

(22) Filed: Oct. 3, 2012

Related U.S. Application Data
(60) Provisional application No. 61/578,298, filed on Dec. 21, 2011.

(51) Int. Cl. C02F 9/00

(52) U.S. Cl. CPC C02F 9/00
USPC 210/638

(57) ABSTRACT

Methods and systems based on membrane separation processes for removal of field chemicals are provided. In certain embodiments, methods and systems for water impurity removal include introducing contaminated water into membrane separation devices, which comprise ultrafiltration, nanofiltration, or a reverse osmosis membranes. In some embodiments, the reverse osmosis system comprises a semi-permeable membrane capable of rejecting substantially all of the monovalent ions, divalent ions, and organic molecules. Examples of impurities which may be removed by this system include kinetic hydrate inhibitor and/or corrosion inhibitor. In certain embodiments, the impurity removal system may comprise one or more impurity removal stages. Some embodiments of the present invention feature a high field chemical removal rate of from about 84 percent to about 99.9 percent, depending on the choice of membranes.

### CROSS-REFERENCE TO RELATED APPLICATION

The present application claims benefit to U.S. Patent Application Ser. No. 61/578,298, filed Dec. 21, 2011, entitled “Removal of Field Chemicals from Produced Water Using Different Membrane Processes and System Development” and is related to U.S. Patent Application Ser. No. 61/544,088, filed Oct. 6, 2011, entitled, “Water Impurity Removal Methods and Systems,” which is hereby incorporated by reference.

### FIELD OF THE INVENTION

The present invention relates generally to methods and systems for removal of field chemicals from produced and process water. More particularly, but not by way of limitation, embodiments of the present invention include methods and systems for treating produced water using different membrane process technologies.

### BACKGROUND

In the production of hydrocarbons, water is often produced concurrently with the hydrocarbons. Sources of the water include naturally-occurring formation water and water injected into the formation from certain types of treatment operations such as secondary operations for production enhancement (e.g. steam or water floods, formation stimulation, etc).

This water produced from subterranean formations often contains impurities. Although water used during a project is frequently reused as much as possible, the water must usually be disposed of. To recycle or dispose of wastewater, contaminants in the water must be removed and/or degraded to ensure that the clean environment is not harmed and chemicals are not released.

Any number of natural-occurring or synthetic impurities may be present in the produced water, including, but not limited to, kinetic hydrate inhibitors and corrosion inhibitors. Kinetic hydrate inhibitors (“KHI”) are sometimes added to a hydrocarbon production flow to prevent hydrate formation in the produced hydrocarbons. Clathrate hydrates are crystalline water-based solids physically resembling ice, in which small non-polar molecules (typically gases) are trapped inside “cages” of hydrogen-bonded water molecules.

These hydrocarbon clathrates compounds are highly undesirable as they cause flow assurance problems for the petroleum industry. In particular, they have a strong tendency to agglomerate and to adhere to pipe walls and plug pipelines. Hydrate formation is particularly acute in produced hydrocarbons when hot hydrocarbons that exit the sea floor are routed into a production pipeline or riser that is surrounded by cold sea water. The immediate cooling of the hydrocarbons by the surrounding cold water often encourages the formation of these hydrates. Hydrates may form solids under a variety of conditions and block the surface of the pipe, which can lead to catastrophe. Hydrates can also be abrasive and deteriorate the pipe wall. Changes in pressure and temperature may cause hydrates to expand releasing explosive gases and increasing pressures to dangerous levels.

Due to the undesirability of hydrates, hydrocarbon producers often attempt to avoid operating conditions that favor the formation of hydrates. Nevertheless, in those circumstances where hydrate formation cannot be avoided, hydrocarbon producers often attempt to prevent or mitigate hydrate formation in the first place.

Various inhibitors exist for the prevention of hydrate formation, either through the prevention of hydrate nucleation and/or hydrate agglomeration. As mentioned above, one type of hydrate inhibitor that is sometimes used to mitigate the formation of hydrates are kinetic hydrate inhibitors.

Unfortunately, kinetic hydrate inhibitors used during hydrocarbon extraction often contaminate the water that is concurrently produced with the hydrocarbons. Typically, it is desired to dispose of the water after its extraction and separation from the concurrently-produced hydrocarbons. Unfortunately, due to environmental concerns and/or stricter regulations, the presence of these inhibitors often prevents disposal or other uses of the contaminated water. Accordingly, it is desired to remove these inhibitors before disposal of the water. Kinetic hydrate inhibitors are, however, a relatively new means for inhibiting hydrate formation. Therefore, the petroleum industry has comparatively little experience with these inhibitors and their removal from water.

Other types of inhibitors that may be added to water include, but are not limited to, corrosion inhibitors. Corrosion inhibitors are chemical compounds that, when added to a liquid or gas, decrease the corrosion rate of a material, typically a metal or an alloy. Corrosion inhibitors work as additives to the fluids that contact the metal or object to be protected. The corrosion inhibitors function by neutralizing corrosive agents such as oxygen, hydrogen sulfide, and carbon dioxide.

Thus, both kinetic hydrate inhibitors and corrosion inhibitors add organic content to the produced water. Many conventional methods exist for removal of field chemicals. Some of the conventional methods include electro-coagulation/flocculation, chemical coagulation, solvent extraction, advanced oxidation processes such as ozonation, wet air oxidation, and catalytic wet air oxidation.

Unfortunately, these conventional methods suffer from a variety of disadvantages. Many of the conventional methods are limited to removing only about 30 to 40% of inhibitors from water (e.g. electrocoagulation/flocculation, chemical coagulation, and solvent extraction). This limited removal rate remains unsatisfactory in many situations.

Some of the conventional methods are further disadvantageous in that they chemically alter the kinetic hydrate inhibitor upon removing it from the water (e.g. coagulation, flocculation, and adsorption processes). Also, conventional methods, due to their nature, lack often automation and require constant attention for quality control (e.g. adsorption columns and chemical coagulation/flocculation). These processes often suffer from quality control problems. Additionally, some of the conventional methods suffer from overly complicated and/or wasteful cleaning or regeneration requirements. Other conventional methods suffer from severe capacity limitations. In some cases, conventional methods suffer from undue complexity, excessive high capital and/or excessively high operational costs.

Accordingly, there is a need for sophisticated separation methods and systems that address one or more of the disadvantages of the prior art. Separation methods are needed to treat the highly organic loaded produced water to be either reintroduced into subterranean formations or further processed without generating toxic by-products that are difficult to dispose of or damaging to the environment.

### SUMMARY

The present invention relates generally to methods and systems for removal of field chemicals from produced and process water. More particularly, but not by way of limitation, embodiments of the present invention include methods and systems for treating produced water using different membrane process technologies.

One example of a method for removal of field chemicals from produced water comprises the steps of: introducing a plurality of field chemicals into a production flow, wherein the field chemicals comprise one of a kinetic hydrate inhibitor and a corrosion inhibitor, wherein the production flow comprises hydrocarbons and a produced water; separating the produced water from the production flow; introducing the produced water to a water pretreatment system for removing a first portion of the field chemicals from the produced water to form a pretreated produced water; introducing the pretreated produced water to membrane separation device, wherein the membrane separation device comprises a reverse osmosis system, wherein the reverse osmosis system comprises a semi-permeable membrane; overcoming an osmotic pressure of the semi-permeable membrane by applying an external pressure to the pretreated produced water to drive the pretreated produced water through the semi-permeable membrane; allowing the semi-permeable to selectively retain a second portion of the field chemicals from the pretreated produced water to form a treated produced water, wherein the membrane separation device has a removal rate of from about 99% to about 100% of the field chemicals fed to the membrane separation device; and disposing of the treated produced water to the environment.

One example of a method for removal of field chemicals from produced water comprises the steps of: introducing a plurality of field chemicals into a production flow, wherein the field chemicals comprise one of a kinetic hydrate inhibitor and a corrosion inhibitor, wherein the production flow comprises hydrocarbons and a produced water; separating the produced water from the production flow; introducing the produced water to a water pretreatment system for removing a first portion of the field chemicals from the produced water to form a pretreated produced water; introducing the pretreated produced water to membrane separation device, wherein the membrane separation device comprises one of an ultrafiltration membrane and a nanofiltration membrane; allowing the semi-permeable to selectively retain a second portion of the field chemicals from the pretreated produced water to form a treated produced water, wherein the membrane separation device has a removal rate of from about 99% to about 100% of the field chemicals fed to the membrane separation device; and disposing of the treated produced water to the environment.

The features and advantages of the present invention will be apparent to those skilled in the art. While numerous changes may be made by those skilled in the art, such changes are within the spirit of the invention.

### BRIEF DESCRIPTION OF THE DRAWINGS

A more complete understanding of the present disclosure and advantages thereof may be acquired by referring to the following description taken in conjunction with the accompanying figures, wherein:

FIG. 1 illustrates an example of a separation process system for removal of field chemicals in accordance with one embodiment of the present invention.

FIG. 2 illustrates a bench scale membrane separation device.

While the present invention is susceptible to various modifications and alternative forms, specific exemplary embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

The present invention relates generally to methods and systems for removal of field chemicals from produced and process water. More particularly, but not by way of limitation, embodiments of the present invention include methods and systems for treating produced water using different membrane process technologies.

In certain embodiments, methods and systems for removal of field chemicals include introducing produced water into a membrane separation device. The removal system may comprise different membranes having certain pore sizes, such as ultrafiltration membranes and nanofiltration membranes. In certain embodiments, the removal system comprises a reverse osmosis system. Where ultrafiltration membranes are used as part of the removal system, the ultrafiltration membrane system may reject particles in the range of micron sizes such as virus and higher molecular weight cut-off organic molecules. The nanofiltration membrane may remove multivalent ionic species as well as partial monovalent ions and molecular weight cut-offs of about 200 Daltons. The reverse osmosis system comprises a semi-permeable membrane comprising a polymer matrix that removes ionic species in the range of atomic scale as well as monovalent ions. Examples of impurities which may be removed by this system include kinetic hydrate inhibitor and/or corrosion inhibitor. In certain embodiments, the removal system may comprise one or more removal stages. Some embodiments of the present invention feature a high removal rate of kinetic hydrate inhibitor from about 82 percent to about 99.9 percent.

As compared to many conventional methods, advantages of certain embodiments of the membrane separation methods and systems described herein include, but are not limited to, one or more of the following:
higher removal rates due in part to higher rejection rates,
allows fractionation and recovery of valuable components,
ease of cleaning of membranes to restore the permeate flux, and
longer term operation without membrane cleaning, particularly when appropriate pretreatment processes are employed.
   Other advantages will be apparent from the disclosure herein.

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations that come within the scope of the invention.

Although the following examples are described with reference to the impurities being kinetic hydrate inhibitor, it is recognized that the following examples may be applied to other impurities which may be found in produced water.

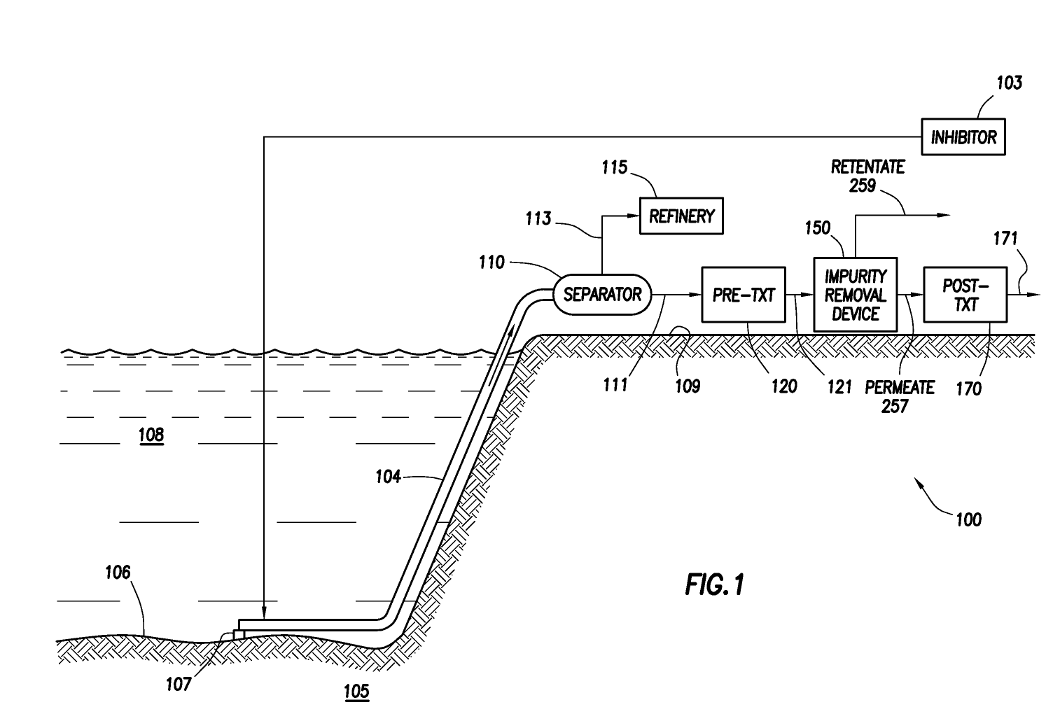

FIG. 1 illustrates an example of a water impurity removal system in accordance with one embodiment of the present invention. In this example, hydrocarbons, such as natural gas, are produced from subterranean formation 105 at wellhead 107. Hydrocarbons produced from subterranean formation 105 are transported via production pipeline 104 to surface 109 along with any water that may be produced along with the desired hydrocarbons. As used herein, the term “produced water” refers to any water that is produced concurrently with subsurface hydrocarbons.

As production pipeline 104 is surrounded by cold sea water 108, any production flow leaving subterranean formation 105 may experience cooling as the production flow is transported to surface 109. Under some conditions, undesirable hydrates may form in the production flow as it is cooled upon leaving subterranean formation 105 and entering production pipeline 104. One way of inhibiting hydrate formation is by introducing kinetic hydrate inhibitor into production pipeline 104 via inhibitor injection line 103. Kinetic hydrate inhibitors function by slowing down the kinetics of the nucleation of hydrate molecules. Other examples of inhibitors that may be added include corrosion inhibitors, which may be added to prevent corrosion of metal and alloy equipment such as production pipeline 104.

The hydrocarbon/water mixture produced from subterranean formation 105 is transported to separator 110 at surface 109. Separator 110 is any device suitable for separating the water from the hydrocarbons. Examples of suitable separators include, but are not limited to, flash drums, centrifuges, slug catchers, or any combination thereof. Separated hydrocarbons 113 are routed via line 115 for subsequent treatment, separation, and/or transport to terminals for sale. Produced water 111, which comprises the water separated from the production flow, flows to optional pretreatment step 120. The pretreatment step 120 may be either dual media or ultrafiltration membrane filters.

Optional pretreatment step 120 is any pretreatment of produced water 111 suitable for preparing produced water 111 for membrane separation device 150, including, but not limited to, removal of relatively large particulates, microfiltration, ultrafiltration, pretreatment with a surfactant, with coagulant/flocculents, with an electrocoagulant, with a floatation unit, with other chemical, physical, or electrical aids (e.g. to grow, agglomerate, or adsorb/adsorb the molecules/particles), with steam destruction, with ozone oxidation, or any combination thereof.

In certain embodiments, pretreatment step 120 comprises a temperature adjustment to cool the produced water 111. Increases in temperature of produced water 111 comprising kinetic hydrate inhibitor may produce precipitate which could significantly impact the membrane performance causing fouling and clogging the pore surface. In certain embodiments, it may be desirable to conduct operation below 40° C. for organic membrane filters.

Advantages of pretreatment step 120 in impurity removal process 100 include reducing the load on membrane separation device 150, particularly as to larger particulates or components which may adversely affect membrane separation device 150. In this way, overall field chemical removal process 100 is more efficient and membrane separation device 150 may be focused on removing more difficult to remove impurities. In certain embodiments, pretreatment step 120 comprises an ultrafiltration membrane.

In some embodiments, no pretreatment step is performed prior to the introduction of produced water to membrane separation device 150. The avoidance of an optional pretreatment step can be advantageous by avoiding additional capital costs.

After pretreatment step 120, pretreated produced water 121 is introduced to membrane separation device 150. Membrane separation device 150 may comprise a semi-permeable membrane that preferably and selectively removes field chemicals from pretreated produced water 121. The semi-permeable membrane may comprise an ultrafiltration membrane, a nanofiltration membrane, or a reverse osmosis membrane. Examples of suitable membranes include, but are not limited to, organic nature based on thin film composite polyamide or cellulose acetate chemistry. These membranes may be operated at temperatures of less than about 40° C. Pre-cooling may be desirable, if the feed to the separation process is higher than about 40° C.

Reverse osmosis is based on a property of certain polymers called semi-permeability. While these membranes are quite permeable for water, their permeability for dissolved substances is low. By applying a pressure difference across the membrane, the water contained in the feed is forced to permeate through the membrane. To overcome the feed side, a fairly higher osmotic pressure is applied.

This reverse osmosis process is similar to other membrane technology applications. Key differences however exist between reverse osmosis and other filtration devices such as ultrafiltration and nanofiltration. The predominant removal mechanism in ultrafiltration is straining, or size exclusion, so the process can theoretically achieve perfect exclusion of particles regardless of operational parameters such as influent pressure and concentration. Reverse osmosis, however, involves a diffusive mechanism so that separation efficiency is dependent on solute concentration, pressure, and water flux rate.

The reverse osmosis process may require a high pressure to be exerted on the high concentration side of the selective membrane, in some cases, at least about 600 psi or from about 600 psi to about 1,200 psi.

Returning to FIG. 1, pretreated produced water 121, is separated into permeate 257 and retentate 259 by membrane separation device 150. Retentate 259 is enriched with inhibitor whereas permeate 257 is substantially depleted of inhibitor by way of the reverse osmosis process described above. In certain embodiments, membrane separation device 150 is configured as a continuous process. It is recognized that retentate 259 may not be used again if it contains more organic loaded with KHI molecules. In certain embodiments, retentate 259 may be subjected to advanced oxidation processes for further degradation of KHI.

Inhibitor removal rates using reverse osmosis are generally higher than other conventional impurity removal methods. In certain embodiments, removal rates of the reverse osmosis range from about 97 to about 100 percent of the inhibitor from the pretreated produced water. In some embodiments, all or a portion of permeate 257 may be recycled to membrane separation device 150 where additional removal is desired. Additionally, membrane separation device 150 may comprise a plurality of reverse osmosis processes in series, in parallel, or both as desired. Once the concentration of kinetic hydrate inhibitor has been reduced to a desired level, the treated water may be disposed of to the environment or recycled for another use.

Permeate 257 may be further treated by optional post-treatment process 171. After treatment by membrane separation device 150, Permeate 257, which comprises mostly water, flows to optional post-treatment step 170. Post-treatment step 170 may comprise any treatment that provides additional impurity removal or which further prepares permeate 257 for disposal to the environment or to a subsequent application. Examples of suitable post-treatment steps 170 include, but are not limited to, post-treating the produced water with another filtration step, with steam destruction, with chemical oxidation, with ozone oxidation, with an extraction step, with an adsorption process, or any combination thereof. If desired post-treatment processing may include mineralization of permeate 257. Mineralization of permeate 257 may be beneficial to mitigate the corrosive effects of permeate 257 inherent to its non-mineralized state.

It is recognized that any of the elements and features of each of the devices described herein are capable of use with any of the other devices described herein without limitation. Additionally, any of the elements or features of the embodiments described in U.S. Patent Application Ser. No. 61/544,088, filed Oct. 6, 2011, titled, “Water Impurity Removal Methods and Systems” may be combined with any of the embodiments described herein. Furthermore, it is recognized that the steps of the methods herein may be performed in any order except unless explicitly stated otherwise or inherently required otherwise by the particular method.

To facilitate a better understanding of the present invention, the following examples of certain embodiments are given. In no way should the following examples be read to limit, or define, the scope of the invention.

### EXAMPLES

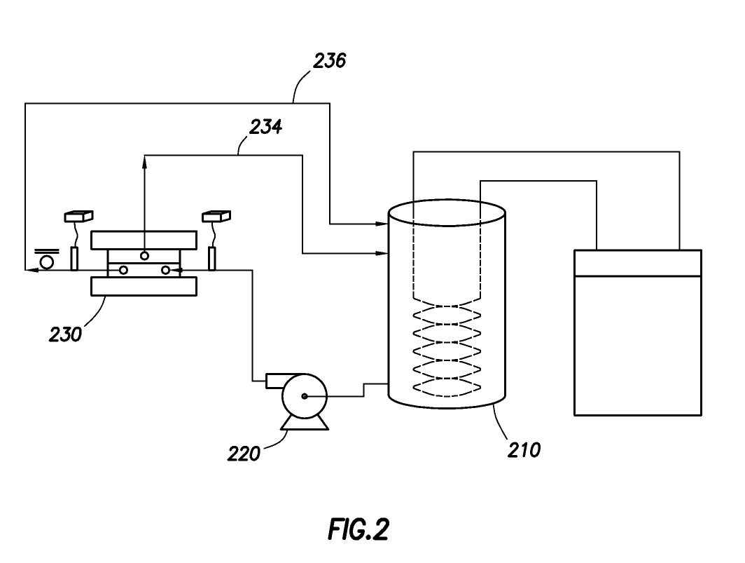

FIG. 2 schematically illustrates an experimental setup to test the efficacy of different membrane separation processes for removing field chemicals from produced water. More specifically, a brine solution having the initial composition is introduced into feed tank 210. In this example, the brine solution has both kinetic hydrate inhibitor and corrosion inhibitor present in significant concentrations. The brine solution is then fed to membrane separation device 230 via pump 220.

Here, membrane cell has potential to test different membranes, for example, ultrafiltration, nanofiltration, and reverse osmosis membranes. The feed pressure may be monitored using pressure transducer if desired. The flux is measured by weight with respect to time and membrane area. Permeate 236 and retentate 234 (i.e. reject stream) are recycled back to the feed tank as shown in FIG. 2.

A series of experiments were carried out using ultrafiltration, nanofiltration, and reverse osmosis membranes. An ultrafiltration membrane was placed in membrane separation device 230. The membrane used in the study was a GE Osmonic (GK series). The operating pressure was kept between about 50 psi and about 62 psi with a membrane area of 0.014 m². The molecular weight cut off was 3,500 based on polyethylene glycol. Initial flux at the start of the experiment was around 13 l/m²·hr. Final flux after 24 hours of experiment showed a flux of 11.9 l/m²-hr, which confirmed no significant decline in the permeate flux. The feed and product conductance were 10.2 mS/cm and 10.1 mS/cm respectively. KHI and corrosion inhibitor rejection were determined to be about 84% and about 5% respectively.

A nanofiltration membrane was placed in membrane separation device 230. The membrane used in this case was a GE Osmonic (Desal-DK series) with a pore size of about 0.48 nm. The operating pressure was kept between about 150 psi and about 175 psi with a membrane area of 0.014 m². Initial flux at the start of the experiment was around 33.7 l/m²-hr. Final flux after 49 hours of experiment showed a flux of 11.4 l/m²·hr, which confirmed no significant decline in the permeate flux. The feed and product conductance were 9.7 mS/cm and 3.6 mS/cm respectively. KHI and corrosion inhibitor rejection are 99.7% and 98.8% respectively. Nanofiltration rejected both the multivalent ions and partial monovalent ions.

A reverse osmosis membrane was also placed in membrane separation device 230. The membrane used in this case was a Toray BWRO. The membrane area was 0.014 m². Initially, the reverse osmosis membrane was compacted using 10 g/l NaCl. The operating pressure was kept at about 500 psi. Initial flux was around 28.7 lmh. The final flux after 14 hours was 10 lmh. Brine with field chemicals experiment was conducted. Initial flux was 15 lmh. The final flux after 22 hours was 10.5 lmh. The operating pressure was kept at 594 psi. The feed and product conductance are 9.5 mS/cm and 0.5 mS/cm respectively, which showed above 99.9% removal of KHI and corrosion inhibitor. After completion of the experiment, tap water was flushed at the surface of the membrane at a higher velocity for about 30 minutes as membrane cleaning. Again the compaction was carried out using 10 g/l NaCl. Initial and final fluxes were 10.8 lmh and 8.8 lmh, which showed that the membrane is able to recover its original permeability and also confirm that KHI was not fouling the membrane surface.

Details results of the experiment are shown in Table 1 with feed composition and rejection of each studied membrane.

TABLE 1
Feed composition & performance of different membranes

| | | Reverse | Nanofiltration | Ultra filtration |
|---|---|---|---|---|
| | Feed | Osmosis | Rejection | Rejection |
| Ions | mg/l | Rejection (%) | (%) | (%) |
| Corrosion | 855.3 | 99.9 | 98.8 | 5.4 |
| Inhibition | | | | |
| Kinetic | 20738 | 100 | 99.7 | 83.3 |
| Hydration | | | | |
| Inhibition | | | | |
| Chloride | 3403.3 | 99.2 | 72.8 | 2.8 |
| Sulphate | 39.9 | 99.0 | 100.0 | 25.0 |
| Phosphate | 292.0 | 99.7 | 100.0 | 16.6 |
| Acetate | 336.6 | 87.8 | 40.3 | 3.0 |
| Sodium | 675.3 | 99.2 | 14.6 | 0.0 |
| Ammonia | 35.5 | 97.8 | −20.8 | −0.5 |
| Potassium | 47.9 | 96.0 | 9.0 | −2.1 |
| Magnesium | 244.8 | 99.7 | 98.9 | 4.2 |
| Calcium | 1016.8 | 99.7 | 97.7 | 1.2 |

Membrane separation device 230 separates the brine solution into permeate 236 and retentate 234. As would be expected, permeate 236 is depleted of inhibitor whereas retentate 234 is substantially enriched with inhibitor. The brine solution was fed at an average constant flow rate of 808 ml/min over a 24 hour period, during which retentate 234 was sampled.

Thus, these experiments show that KHI may be rejected efficiently by various membrane processes. Ultrafiltration, nanofiltration, and reverse osmosis membranes rejected KHI at removal rates of about 84%, 99%, and 99% respectively. Additionally, these experiments confirm that corrosion inhibitor is also efficiently rejected by both nanofiltration and reverse osmosis membranes. Reverse osmosis membranes were able to restore its original permeate flux based on compaction experiments which suggest that the membranes do not become significantly fouled during these removal processes.

Thus, these results show a high removal rate of inhibitor depending on the choice of the membrane (e.g. both kinetic hydrate inhibitor and corrosion inhibitor) in addition to other monovalent and bivalent ions.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations and equivalents are considered within the scope and spirit of the present invention. Also, the terms in the claims have their plain, ordinary meaning unless otherwise explicitly and clearly defined by the patentee.

What is claimed is:

1. A method for removal of field chemicals from produced water comprising the steps of:
introducing a plurality of field chemicals into a production flow, wherein the field chemicals comprise one of a kinetic hydrate inhibitor and a corrosion inhibitor, wherein the production flow comprises hydrocarbons and a produced water;
separating the produced water from the production flow;
introducing the produced water to a water pretreatment system for removing a first portion of the field chemicals from the produced water to form a pretreated produced water;
introducing the pretreated produced water to membrane separation device, wherein the membrane separation device comprises a reverse osmosis system, wherein the reverse osmosis system comprises a semi-permeable membrane;
overcoming an osmotic pressure of the semi-permeable membrane by applying an external pressure to the pretreated produced water to drive the pretreated produced water through the semi-permeable membrane;
allowing the semi-permeable to selectively retain a second portion of the field chemicals from the pretreated produced water to form a treated produced water, wherein the membrane separation device has a removal rate of from about 99% to about 100% of the field chemicals fed to the membrane separation device; and
disposing of the treated produced water to the environment.

2. The method of claim 1 wherein the semi-permeable membrane comprises a polymer matrix that has a molecular weight cut-off of no more than about 200 to about 500.

3. The method of claim 1 wherein the external pressure is at least about 600 psi.

4. The method of claim 1 wherein the external pressure is from about 600 psi to about 1,200 psi.

5. The method of claim 1 wherein the water pretreatment system comprises one of a chemical clarification, a microfiltration process, and an ultrafiltration process.

6. The method of claim 1 wherein the water pretreatment system comprises an ozone oxidation process for oxidizing the inhibitor.

7. The method of claim 1 wherein the step of disposing further comprises the step of irrigating an agricultural field with the treated produced water.

8. The method of claim 1 wherein the step of disposing further comprises the step of disposing of the treated produced water to a deep well injection.

9. The method of claim 1 further comprising the step of mineralizing the treated produced water.

10. The method of claim 1 further comprising the step of recycling at least a portion of the second portion for reuse.

11. The method of claim 1 wherein the plurality of impurities comprise the kinetic hydrate inhibitor and the corrosion inhibitor.

12. The method of claim 1 wherein the step of introducing the impurities into the production flow further comprises the step of introducing the impurities into the production flow at an injection point in a production pipeline in proximity to a sea floor from which the production flow is extracted.

13. The method of claim 1 further comprising the step of decreasing the temperature of the produced water prior to the step of introducing the produced water to a membrane separation device.

14. The method of claim 1 wherein the step of introducing the produced water to the water pretreatment system comprises one of: the step of pretreating the produced water with a surfactant, pretreating the produced water with a coagulant, pretreating the produced water with an electrocoagulant, pretreating the produced water with a floatation unit, pretreating the produced water with other chemical, physical, or electrical aids, pretreating the produced water with steam destruction, and pretreating the produced water via a temperature adjustment of the produced water.

15. The method of claim 1 further comprising the step of post-treating the treated produced water after the step of introducing the produced water to the membrane separation device.

16. The method of claim 15 wherein the step of post-treating the treated produced water comprises subjecting the treated produced water to an advanced oxidation process for further degradation of kinetic hydrate inhibitor.

17. The method of claim 1 wherein the field chemicals comprise a kinetic hydrate inhibitor and a corrosion inhibitor.

18. A method for removal of field chemicals from produced water comprising the steps of:
introducing a plurality of field chemicals into a production flow, wherein the field chemicals comprise one of a kinetic hydrate inhibitor and a corrosion inhibitor, wherein the production flow comprises hydrocarbons and a produced water;
separating the produced water from the production flow;
introducing the produced water to a water pretreatment system for removing a first portion of the field chemicals from the produced water to form a pretreated produced water;
introducing the pretreated produced water to membrane separation device, wherein the membrane separation device comprises one of an ultrafiltration membrane and a nanofiltration membrane;
allowing the semi-permeable to selectively retain a second portion of the field chemicals from the pretreated produced water to form a treated produced water, wherein the membrane separation device has a removal rate of from about 99% to about 100% of the field chemicals fed to the membrane separation device; and
disposing of the treated produced water to the environment.

19. The method of claim 18 wherein the membrane separation device comprises an ultrafiltration membrane and a nanofiltration membrane.

20. The method of claim 18 wherein the semi-permeable membrane has a molecular weight cut-off of from about 500 to about 1,000.

21. The method of claim 18 wherein the semi-permeable membrane has a molecular weight cut-off of from about 1,000 to about 2,000.
